(19) United States
(12) Patent Application Publication
(10) Pub. No.: US 2007/0259070 A1
(43) Pub. Date: Nov. 8, 2007

(54) INFRA-RED CURING PROCESSES FOR CONFECTIONERY COATINGS

(76) Inventors: Joo Song, Chicago, IL (US); Kangwook Lee, Naperville, IL (US)

Correspondence Address: BELL, BOYD & LLOYD LLP, P.O. Box 1135, CHICAGO, IL, 60690, US

(21) Appl. No.: 11/381,500

(22) Filed: May 3, 2006

(51) Int. Cl. A23G 4/18

(52) U.S. Cl. 426/5

(57) ABSTRACT

Methods for manufacturing coated confectionery products are provided. In an embodiment, the method comprises providing a confectionery, applying at least one coating to the confectionery to produce a coated confectionery, and applying infra-red radiant energy to the coated confectionery.

### BACKGROUND

The present invention relates generally to confectionery products. More specifically, the present invention relates to improved methods for making confectionery coatings.

There are numerous types of confectionery products for consumers such as, for example, chewing gum, hard candy and soft candy. These confectioneries can have one or more outer coatings. The coatings can serve many purposes. For example, the coating can provide a barrier to limit moisture migration into and out of the confectionery center. The coatings can provide an initial sweetness or other desirable organoleptic property to the consumer. Further, the coatings can provide a crunching sensation when chewed by the consumer.

Initially, in creating coated chewing gums or other confectioneries, sugar syrups or similar solutions can be used to create the coating. Solutions, which may be in a liquid state at high temperature, contain a water component wherein the solute is dissolved or suspended. The coating is often achieved by spraying the hot solution onto the base confectionery item, spreading the syrup to distribute material onto all confectionery items, then cooling and drying the syrup solution to afford a solid coating.

Despite their widespread popularity in the confectionery industry, conventional solution-based coatings such as sugar syrups require repeated cycles of spraying, distributing and to achieve a final coating that is sufficiently thick. The repeated spraying and drying process is complicated by the fact that drying each application typically requires the introduction of hot, dry air to remove moisture before spraying the next coat. This is due to the fact that solutions-based coatings have a moisture content that provides for the liquid property of the solution. This liquid characteristic is necessary for the coating solution to be sprayed or otherwise conveniently applied to the confectionery item. Of course, however, the moisture component must be removed after application in order for the coating to be transformed to a solid state. These repeated cycles of spraying, distributing and drying are time-consuming and require specialized equipment.

Polyol solutions and molten polyols have also been used for coating confections, including chewing gums. Polyol solutions, however, are similar to conventional sugar solutions in that they require repeated cycles of application and drying to remove the inherent water component contained therein.

There is therefore a need for improved methods for generating coatings on chewing gums and other confections.

### SUMMARY

The present invention provides improved methods for drying and/or solidifying the coating of confectionery products. In an embodiment, the present invention provides a method comprising providing a coated confectionery; and applying infra-red radiant energy to the coated confectionery. For example, the infra-red radiant energy can be applied to the coated confectionery at an intensity ranging from about 50-400 Watts/min (W/min). The infra-red radiant energy can be applied to the coated confectionery from about 1-60 minutes.

In an embodiment, the method comprises rotating the coated confectionery while the infra-red radiant energy is applied. For example, the coated confectionery can be rotated at a speed ranging from about 5-50 rpms.

In an embodiment, the method comprises supplying air flow to the coated confectionery while the infra-red radiant energy applied. For example, the air flow can be supplied at a rate ranging from about 0.125-2.5 m³/min/kg of the coated confectionery. The air flow can also have a temperature ranging from about 20-70° C.

In an embodiment, the confectionery can be a hard candy, gummy candy, jelly candy, chewy candy, chewing gum, chocolate, fondants, nougats, compound candy, caramels, taffies, dragees, suspensions, lozenges, compressed tablets, capsules, nuts, snack foods or combinations thereof.

In another embodiment, the present invention provides a method comprising: providing a confectionery; applying at least one coating to the confectionery to produce a coated confectionery; and applying infra-red radiant energy to the coated confectionery.

In an embodiment, the method comprises supplying air flow to the confectionery while the coatings are applied and/or while the infra-red radiant energy is being applied.

In an embodiment, the coating can comprise a syrup having an ingredient selected from the group consisting of sugar sweeteners, sugar-free sweeteners, polyols, flavors, colors and combinations thereof.

In an embodiment, the coating can comprise a molten polyol selected from the group consisting of sorbitol, maltitol, xylitol, erythritol, mannitol, isomalt, lactitol and combinations thereof.

In an alternative embodiment, the present invention provides a method of manufacturing a coated confectionery. For example, the method comprises providing a confectionery; applying a plurality of coating layers to the confectionery to form a coated confectionery; rotating the coated confectionery; and applying infra-red radiant energy to the rotating coated confectionery. The plurality of layers can include at least one coating layer having a component selected from the group consisting of molten polyol, polyol syrup, sugar syrup and combinations thereof.

In an embodiment, the plurality of layers including at least one coating layer can have a component selected from the group consisting of molten polyol, polyol syrup, sugar syrup and combinations thereof. Applying the plurality of coating layers can be chosen from the group consisting of spraying, panning and combinations thereof.

In an embodiment, the coating layer can comprise other ingredients such as suitable sugar sweeteners, sugar-free sweeteners, polyols, flavors, colors and combinations thereof.

In various embodiments, the present invention provides for compositions that are produced by the various methods embodied herein.

It is an advantage of the present invention to provide improved coatings for confectionery products as well as improved methods for forming such coatings.

Yet another advantage of the present invention is to reduce the crystallization development time for confectionery coatings.

Still another advantage of the present invention is to reduce the time for removing moisture from confectionery coatings to achieve a finished coated confectionery.

Additional features and advantages are described herein, and will be apparent from, the following Detailed Description and the figures.

### BRIEF DESCRIPTION OF THE FIGURES

FIG. 1 illustrates sensory results of the IR treated sorbitol coated pellets including 2 control samples.

FIG. 2 illustrates softening points of test samples of the IR treated sorbitol coated pellets using TMA.

FIG. 3 illustrates the effect of IR treatment versus non-IR treatment on the sorbitol coated pellets.

### DETAILED DESCRIPTION

The present invention provides for improved methods for generating confectionery coatings. More specifically, the present invention provides for improved methods of making coated confectioneries using infra-red (IR) radiant energy. Although in the preferred embodiments set forth below, the confectionery product is chewing gum, the present invention is not limited to chewing gum. The present invention can be used to various foodstuff coatings and preferably confectionery products.

In an embodiment, the present invention provides an improved method of curing a confectionery coating by using IR radiant energy (e.g. IR treatment). For example, the method can comprise providing a confectionery, applying at least one coating to the confectionery to produce a coated confectionery, and applying infra-red radiant energy to the coated confectionery. Generally, the IR technology can provide faster processing to reach a hard, crunchy coating as compared to conventional air drying and tempering (i.e. post-coating air drying) alone.

In the present specification, the term “curing” should be understood to mean drying, facilitating crystal reorganization and/or facilitating the solidification of the coating. For example, curing the coatings surrounding confectionery products can involve removing moisture from the coatings and/or causing a crystalline structure to form within the coatings. It should be appreciated that the formation of the crystalline structure can occur in those coating compositions capable of achieving a crystalline structure (e.g. sorbitol). Curing can also generally involve the solidification of the coating surrounding the confectionery.

It was surprisingly found that using IR treatment expedited moisture removal from and assisted in the crystalline formation of coatings for confectionery products (e.g. assisted the curing of the coating). Reducing the drying time, for example, can reduce capital and energy expenditures associated with the equipment necessary to the drying process. Additionally, enhanced crystallization of the coating during IR treatment can provide, for example, an improved coated confectionery product that gives a crunchier coating even after a long storage time.

A time consuming component of confectionery coating processes can be associated with the complete drying of water used to apply and distribute the coating solids in onto the confectionery centers in the hard panning process. Significant process time savings can be realized through providing infra-red radiant energy to expedite the removal of water content and crystallization/solidification of the coating. With sorbitol, in particular, the IR treatment can create a crunchy coating (e.g. crystalline coating) in a relatively short amount of time (e.g. hours) whereas to achieve the same hard coating using standard air drying alone could take weeks.

In an embodiment, the IR treatment process of the present invention can be a post-processing step applied after a conventional coating procedure (e.g. coating application followed by tempering). For example, the conventional coating procedure can be, for example, a pan coating process, a spray coating process and other coating applications known by those skilled in the art. Sugar-based syrups, molten polyols and/or other suitable confectionery coating formulas can be applied using any suitable coating process. The coating formulas can also be applied in any suitable number of layers to cover the confectionery and to achieve a sufficient coating thickness prior to the IR treatment. After the final coating is applied to the confectioneries, the coated confectioneries can also be tempered (e.g. subject to air drying) for a suitable amount of time before the IR treatment.

Molten polyols can be applied, for example, by atomizing spray application, to the gum center while the polyols are in a molten state. Thereafter, the coated gum can be exposed to IR radiant energy, which assists the polyol in transforming from a molten state back to a solid and/or crystalline state.

A preferred polyol for use in the present invention is sorbitol. Sorbitol is a preferred polyol due to its reduced cost as compared to xylitol. However, it should be appreciated that any other polyols can be used with the present invention. For example, other such suitable polyols include, but are not limited to, maltitol, xylitol, erythritol, mannitol, isomalt, lactitol and combinations thereof.

The coatings of the present invention may include non-polyol ingredients which are commonly used in sugar and sugarless coatings. For example, sugar products such as sucrose, fructose, maltose, glucose, dextrose, and trehalose or combinations thereof could be applied from a molten state to provide a hard-coated sugar confectionery or other center/core. The specific ingredients and their usage levels will vary greatly according to the intentions for the formulation.

The use of one or more fillers (e.g., titanium dioxide, talc, calcium carbonate, silicon dioxide) in the present invention is especially advantageous. In this regard, these inorganic materials aid the coating process by giving the molten polyol coatings a smoother finish, especially when using molten polyols having a higher melting point, such as maltitol. Furthermore, these inorganic fillers enhanced the ease with which molten sorbitol could be used, and in many instances substantially increased the crunchiness of the product. These fillers also appear to facilitate crystallization of the applied polyol once the molten material adheres to the centers being coated. Without adding an inorganic filler to molten sorbitol, the coating is excessively sticky, causing coating problems, e.g., the pellets may stick together. Likewise, without inorganic filler added to molten maltitol, the spray exiting the nozzle is unsuitable for coating smooth pellets. Moreover, the use of non-polyol can reduce the spider-web structures created by spraying maltitol.

Various polyols may not be identical in their physical and chemical characteristics. The variability among the polyols therefore allows one to blend two or more different molten polyols prior to application. Similarly, it may be desirable to build-up multiple coating layers using single or blended polyols for the individual coating layers.

Molten polyol coatings can result in a finished product that, when compared to conventional non-molten coatings, is rougher in appearance. In the present specification, the term “molten” (e.g. molten sorbitol) should be understood to refer to a solid composition that is heated to its melting point thereby forming a liquid or viscous material. As a result, a molten composition is distinguished from a syrup composition, which generally refers to a solution made by dissolving a powdered composition in a liquid.

In the present specification, the term “conventional non-molten coatings,” and like terms, are intended to broadly refer to any coating substance or syrup that is not in a molten state, but dissolved or dispersed in an aqueous or other solvent-based media, and applied to a given confectionery item. A non-molten coating can include, but is not limited to, sugar syrups, polyol syrups, other solutions, suspensions, pastes, and gels.

It is also possible to produce a coated confectionery containing the molten polyol, potentially with high intensity sweeteners, flavor, color, filler, binder, or film forming agents having a rough texture or appearance. For example, a frosted, flavored or sweetened coating could be applied to confectionery products to provide an alternative surface finish and means of introducing a high-initial-impact product.

Additionally, it may be desirable to initially establish at least one coating layer using at least one conventional non-molten coating, over which at least one molten polyol coating may be applied. Similarly, depending on the desired outcome, it may be preferable to employ alternating layers of molten polyol coatings and conventional non-molten coatings. Therefore the molten polyol coatings can be utilized as the sole coating or can be utilized in combination with one or more other coating layers that comprise any type of conventional non-molten coating.

The molten polyols can be melted by methods known in the art. In an embodiment, the polyol is liquefied by heating a composition that includes 5% or less water. By way of example and not limitation, the coating materials can be melted by using a hotmelt apparatus such as the ROBATECH® Hotmelt Unit. However, other means such as a steam jacketed melting tank can be used.

It may be desirable to provide chewing gum products that have different coating layers comprising molten polyols and conventional non-molten coatings. In this regard, both such coating types can be applied using methods known in the art, such as spraying the coating materials onto the gum pellets. Spraying can be alternately started and stopped to allow layers of coating to dry onto the surface of the pieces. Supplying forced air and dry powder during the coating process additionally may be used to speed the drying process. The various parameters of the operation (spray time, dry time, air temperature, tumbling speed and others) will vary greatly from one system to another and may well vary within a coating batch and from batch to batch. They will be set based on the skill and experience of the developer and operator.

In addition to the coatings of the present invention applied by spraying, optional flavors may be separately sprayed onto the pieces during the coating process to provide a flavored coating. If used, this flavor may constitute from about 0.01 to 3% of the total coating with levels of 0.5 to 2% being preferred.

Optionally, a final polishing coat may be applied to the pieces after the polyol coatings have been applied. The polishing coat may use a wax, such as carnauba wax, or shellac. It may also include fillers such as talc and colors. The polishing coat is typically 0.01 to 0.5% of the total coating.

As noted above, the present invention can be used to create coated chewing gum. A variety of chewing gum formulations can be used to create the chewing gum center. Chewing gum generally consists of a water insoluble gum base, a water soluble portion and flavors.

The insoluble gum base generally comprises elastomers, resins, fats and oils, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

In an embodiment, the chewing gum of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters, often called estergums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, softeners, emulsifiers, colors, acidulants, fillers, antioxidants, and other components that provide desired attributes.

The softeners, which are also known as plasticizers and plasticizing agents, generally constitute between approximately 0.5 to about 15% by weight of the chewing gum. The softeners may, in addition to including caprenin, include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk sweeteners typically constitute 5 to about 95% by weight of the chewing gum, more typically, 20 to 80% by weight, and more commonly, 30 to 60% by weight of the gum.

Sugar sweeteners generally include saccharide-containing components commonly known in the chewing gum art, including, but not limited to, sucrose, dextrose, maltose, dextrin, dried invert sugar, fructose, levulose, galactose, corn syrup solids, and the like, alone or in combination. Sugarless sweeteners can include, but are not limited to, sugar alcohols such as sorbitol, mannitol, xylitol, hydrogenated starch hydrolysates, maltitol, lactitol, and the like, alone or in combination.

High intensity artificial sweeteners can also be used in combination with the above. Preferred sweeteners include, but are not limited to sucralose, aspartame, aspartame derivatives and conjugates, such as neotame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8%. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low caloric bulking agents include: polydextrose; Raftilose, Raftilin; Fructooligosaccharides (NutraFlora); Palatinose oligosaccharide; Guar Gum Hydrolysate (Sun Fiber); or indigestible dextrin (Fibersol). However, other low calorie bulking agents can be used.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

A variety of processes for manufacturing chewing gum center are possible as is known in the art. For example, chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time, along with syrup and a portion of the bulking agent. Further portions of the bulking agent may then be added to the mixer. A flavoring agent is typically added with the final portion of the bulking agent. The entire mixing procedure typically takes from five to fifteen minutes, but longer mixing times may sometimes be required. Those skilled in the art will recognize that many variations of the above described procedures may be followed.

Once formed, the chewing gum center can be coated using a variety of coating processes. For example, in conventional panning, the coating is initially present as a liquid syrup which contains from about 30% to about 80% or 85% of the coating ingredients previously described herein, and from about 15% or 20% to about 70% of a solvent such as water. In general, the coating process is carried out in conventional panning equipment. Sugarless gum center tablets to be coated are placed into the panning equipment to form a moving mass.

In the conventional panning process, the material or syrup which will eventually form the coating is applied or distributed over the gum center tablets. Flavors may be added before, during and after applying the syrup to the gum centers. Once the coating has dried to form a hard surface, additional syrup additions can be made to produce a plurality of coatings or multiple layers of coating.

In the conventional panning procedure, syrup is added to the gum center tablets at a temperature of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup may be mixed with, sprayed upon, poured over, or added to the gum center tablets in any way known to those skilled in the art.

In some instances, a soft coating is formed by adding a powder coating after a liquid coating. The powder coating may include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Preferably, no more than about 75 coats are applied to the gum center. More preferably, less than about 60 coats are applied and most preferably, about 30 to 60 coats are applied. In any event, the present invention contemplates applying an amount of molten polyol and syrup sufficient to yield a coated chewing gum product containing about 10% to about 65% coating. Preferably, the final product will contain at least 30% coating.

Those skilled in the art will recognize that in order to obtain a plurality of coated layers, a plurality of premeasured aliquots of coating syrup may be applied to the gum center. It is contemplated, however, that the volume of aliquots of syrup applied to the gum center may vary throughout the coating procedure.

In the conventional coating process, once a coating of syrup is applied to the gum center, the wet centers are tumbled briefly with no air flow to uniformly distribute syrup across all pellets of the bed, and then drying is done on the wet syrup in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possess a relative humidity of less than about 15 percent. Preferably, the relative humidity of the drying air used between syrup applications is less than about 8 percent.

The drying air may be passed over and admixed with the syrup coated gum centers in any way commonly known in the art. Preferably, the drying air is blown over and around the syrup coated gum centers at a flow rate, for large scale operations, of about 2800 cubic feet per minute. If lower quantities of material are being processed, or if smaller equipment is used, lower flow rates would be used. If a flavor is applied after a syrup coating has been dried, the present invention contemplates drying the flavor with or without the use of a drying medium.

Examples of applying a molten polyol coating to a confectionery center include the steps of providing a confectionery center, heating at least one polyol to the polyol's melting point to produce a molten polyol, spraying the molten polyol through at least one atomizing spray nozzle, and applying a plurality of layers to the confectionery center to form a final coating. The plurality of layers can include one or more layers of the molten polyol. One or more layers of molten polyol or a syrup composition may be applied to the confectionery center prior to spraying. Additional flavor layers may be added to the confectionery center. It should be appreciated that any suitable arrangement of molten polyol, syrup composition and flavor layers may be applied.

The plurality of layers of the molten polyol can form the entire coating having a smooth surface over the confectionery center. A plurality of layers of the molten polyol and a syrup composition can form the final coating with more than 50% of the coating mass resulting from the molten polyol composition. A plurality of layers of the molten polyol and a syrup composition form the final coating with more than 10% of the coating mass resulting from the molten polyol composition.

Replacement of some of the conventional syrup coating mass by molten polyol (by reducing the number of syrup addition cycles) can be done to provide identical surface finish, weight, appearance, texture, and organoleptic properties. This typically encompasses 5-65% of the coating mass to be applied via molten polyol spray application in lieu of conventional coating syrup, more preferably 10-45%, and most preferably 15-40%. In these cases, use of conventional coating syrups are often used to provide good binding of coating layers to the chewing gum core, or to provide a smooth, hard coated finish typical of current commercial products available on the market. It should be appreciated that new coating texture, non-conventional coating appearance, and textures not typically associated with commercial chewing gum products commercially available can be obtained if no conventional coating syrup is used in conjunction with molten polyol spray applications, or if molten polyol sprays are used for a majority of the coating process, or as finishing stages of a conventional coating process.

Applying layers of the molten polyol and/or conventional syrup to the confectionery center can include the steps of mixing with, spraying upon, pouring over or any other suitable method of applying the syrup composition to the confectionery center. Each layer of molten polyol and syrup may be dried before another layer is applied.

Molten polyol application rates can be given in a coating rate value of % coating applied/minute. This percentage is given as coating weight/confectionery center weight. For example, the preferred molten polyol application rate is 0.04%/minute to 2.00%/minute. This corresponds to nozzle rates of 25 g/minute/nozzle to 1250 g/minute/nozzle and spray rates of 0.5 kg/min to 25 kg/minute. More preferably, the molten polyol application rate is 0.08%/minute to 1.28%/minute. This corresponds to nozzle rates of 50 g/minute/nozzle to 800 g/minute/nozzle and spray rates of 1.0 kg/min to 16.0 kg/minute. Most preferably, the molten polyol application rate is 0.24%/minute to 0.64%/minute. This corresponds to nozzle rates of 150 g/minute/nozzle to 400 g/minute/nozzle and spray rates of 3.0 kg/min to 8.0 kg/minute.

The lower ends of these ranges can be used for coating soft, thermally sensitive centers due to the high heat load or cooling demand of the latent and sensible heat being applied via the molten polyol. Coating of chewing gum centers which may soften, deform, or melt due to the heat conducted via the applied coating could be addressed using very cold process air, or precooling gum centers prior to coating with molten polyols.

The upper ends of these application rate ranges may be used for coating of hard candy centers and other confectionery materials which may be better able to tolerate greater heat loads. Alternatively, higher application rates of molten polyols may be used for much shorter duration and intervals which may allows adequate cooling between applications.

Other preferred operating conditions can utilize higher or lower molten polyol spray rates with concomitant increases or decreases in atomizing air flow rates in order to maintain a uniform and finely atomized mist of polyol droplets. Atomized air flow rates set too low for a given molten polyol delivery rate can result in incomplete atomization, spitting, and macroscopic dripping of molten polyol from the nozzle tip. Atomized air rates set too high can result in a dusty polyol mist which can cool and solidify prior to contacting the confectionery centers, and resulting in low process yields. Atomization air temperatures can be set based upon molten and atomizing air spray rates, and are adjusted to minimize freezing of polyol on the nozzle tip and maintain a the finely atomized polyol in a molten state until it has the opportunity to attach and solidify on the centers being coated. This combination of air and molten polyol affords good atomization and fine mist of molten droplets which coats the pellets well.

The molten polyol may be applied prior to the application of the syrup composition. Alternatively, the syrup composition may be applied prior to the application of the molten polyol. The molten polyol may be applied concomitantly or as a blend with the syrup composition. In addition, a dry charge may be added during or between any layer application. The dry charge may be any relevant substance added in a dry or powdered form. The sequences of applying the syrup composition and molten polyol may be repeated any number of times in order to build up the mass of coating material as is desired. Applying the syrup composition, a dry charge, or molten polyol may be performed in any sequence with any combination of mass applications, cooling, spreading (e.g. rotating), and drying in order to accomplish the desired finish product results.

### Infra-Red Curing Applications

Certain embodiments of the methods for IR curing of the coatings on confectionery products according to the present invention will be described below. In an embodiment, the present invention provides a method comprising providing a coated confectionery and applying IR radiant energy to the coated confectionery. The IR radiant energy can by applied at any time after one or more coatings have been applied. The previously applied coatings can be applied in any suitable manner (e.g. from coating processes as discussed above), have any suitable amount of layers and have any amount of moisture prior to being treated with IR radiant energy.

The IR radiant energy can be applied to the coated confectionery at an intensity ranging from about 50-400 Watts/min (W/min). The IR radiant energy can be applied to the coated confectionery for any suitable amount of time such as, for example, from about 1-60 minutes. It should be appreciated that any suitable technology or device that can emit IR radiant energy can be used in various embodiments of the process of the present invention.

The method can further comprise rotating the coated confectionery while the IR radiant energy is applied. This allows the more surface area of the confectionary coating to be exposed to the IR radiant energy during the IR treatment process. For example, the coated confectionery can be rotated at a speed ranging from about 5-50 rpms.

In an embodiment, the method comprises supplying air flow to the coated confectionery while the IR radiant energy applied. The additional air flow can aid in the removal of the water from the various coating syrup formulations. For example, the air flow can be supplied at a rate ranging from about 0.125-2.5 m³/min/kg confectionery (e.g. per weight of coated pellets to be treated with IR). The air flow can also have a temperature ranging from about 20-70° C.

It should be appreciated that any suitable confectionery can be coated and treated with the IR in accordance with embodiments of the present invention. For example, the confectioneries can be a hard candy, gummy candy, jelly candy, chewy candy, chewing gum, chocolate, fondants, nougats, compound candy, caramels, taffies, dragees, suspensions, lozenges, compressed tablets, capsules, nuts, snack foods or combinations thereof.

The coating compositions (e.g. formulations) can comprise a syrup having an ingredient selected from the group consisting of sugar sweeteners, sugar-free sweeteners, polyols, flavors, colors and combinations thereof. The coatings can also comprise a suitable molten polyol such as sorbitol, maltitol, xylitol, erythritol, mannitol, isomalt, lactitol and combinations thereof.

In an alternative embodiment, the present invention provides a method of manufacturing a coated confectionery. For example, the method comprises providing a confectionery; applying a plurality of coating layers to the confectionery to form a coated confectionery; rotating the coated confectionery; and applying IR radiant energy to the rotating coated confectionery. The plurality of layers can include at least one coating layer having a component selected from the group consisting of molten polyol, polyol syrup, sugar syrup and combinations thereof. The plurality of coating layers can be applied by any suitable coating process such as spraying, panning and combinations thereof. The temperature of the chamber during the IR treatment can be any suitable temperature such as, for example, from about 200-2000° C.

The following table provides additional examples of ranges of various aspects of the IR curing process.

TABLE 1

| General IR Treatment | Approximate | | |
|---|---|---|---|
| Conditions | Broad range | Preferred range | Unit |
| Residence time | 1-60 | 5-20 | min |
| IR intensity | 50-400 | 100-200 | W/in |
| Drying air flow rate | 0.125-2.5 | 0.25-1.25 | m³/min/kg |
| Temperature of drying air | 20-70 | 20-40 | ° C. |
| Rotating speed | 5-50 | 10-20 | rpm |

### EXAMPLES

By way of example and not limitation, the following examples are illustrative of various embodiments of the present invention and further illustrate experimental testing conducted with the coating processes in accordance with embodiments of the present invention.

### Example 1

An objective of the trials was the pilot scale test of sorbitol pellet coating technology using IR radiant energy curing. The effects of IR radiant energy curing conditions were evaluated with sorbitol coated pellets, which were produced in test tubes and a DRIAM® 1200 coating machine.

Previously developed sorbitol coated pellets required 6 hr coating time and 12 hr tempering time with conditioned air. Main features of the previously developed coating methods were single low brix syrup coating and flavor mixed syrup spray. Even though the coated pellets were comparable with existing isomalt pellets, long coating and curing time were the main obstacles for commercialization.

Lab scale tests showed promising results of 4 hr coating time and reduced curing requirements. The pilot scale tests were required to evaluate large scale operation and standard wrapping effects.

Test Conditions:

The test pellets were coated with a sorbitol formulation in a DRLAM® 1200 coating machine. An initial R&D sorbitol coating recipe was modified to accommodate molten sorbitol spray. 60 kg of pellet centers were used for 1 batch and 90 kg of coated pellets were produced.

The change of the sorbitol coating recipe was minimized to maintain consistent sorbitol coated pellet for IR curing tests. Sorbitol syrup coated and molten sorbitol coated pellets were produced for comparison. The DRIAM® 1200 coating machine and ROBOTECH® molten spraying system were used for the sorbitol coating trials. The final pellet amount from the single batch was about 90 kg. The produced pellets were stored in the silo tubes or driam for curing.

The coated pellets were first tempered (e.g. subject to drying air) in test tubes and the DRIAM® 1200 coating machine to evaluate the various tempering conditions prior to IR treatment. The airflow pattern and air contact area during the tempering are different for the silo tube and driam. Although the tubes and the driam offered different testing conditions, they provided qualitative comparison of the sorbitol coated pellets.

The sorbitol coated pellets were then treated with IR radiant energy to improve the pellet coating crunchiness. IR treatment of the coated pellets was performed in the rotating drum. The coated pellets were put into a drum, and the drum was rotated as IR lamps supplied IR radiant energy. The IR treatment time was fixed at 10 minutes. IR treated and untreated samples were produced.

TABLE 2

| | | Air | Air | Tempering | |
|---|---|---|---|---|---|
| | | flowrate | temperature | Time | |
| | | (m³/min) | (° C.) | (pre-IR | IR |
| Sample | | (pre-IR | (pre-IR | treatment) | treatment |
| ID | Equipment | treatment) | treatment) | (hr) | (min) |
| #1 | Tube | 0.228 | 60 | 6 | 10 |
| #2 | Tube | 0.057 | 20 | 6 | 10 |
| #3 | Tube | 0.057 | 70 | 6 | 10 |
| #4 | Tube | 0.228 | 70 | 6 | 10 |
| #5 | Tube | 0.057 | 20 | 6 | 10 |
| #6 | Tube | 0.057 | 60 | 6 | 10 |
| #7 | Tube | 0.228 | 60 | 6 | 10 |
| #8 | Driam | 8.5 | 50 | 12 | 10 |
| #9 | Driam | 12 | 40 | 6 | 10 |
| #10 | Driam | 12 | 50 | 6 | 10 |
| #11 | Driam | 8.5 | 50 | 12 | 10 |

The finished sorbitol coated pellets were wrapped after the IR treatment. The wrapped pellets were stored at typical factory conditions and submitted for further pellet evaluation. The samples were stored in a conditioned room before the wrapping, so the effect of wrapping timing would not be very significant.

Pellet Evaluations:

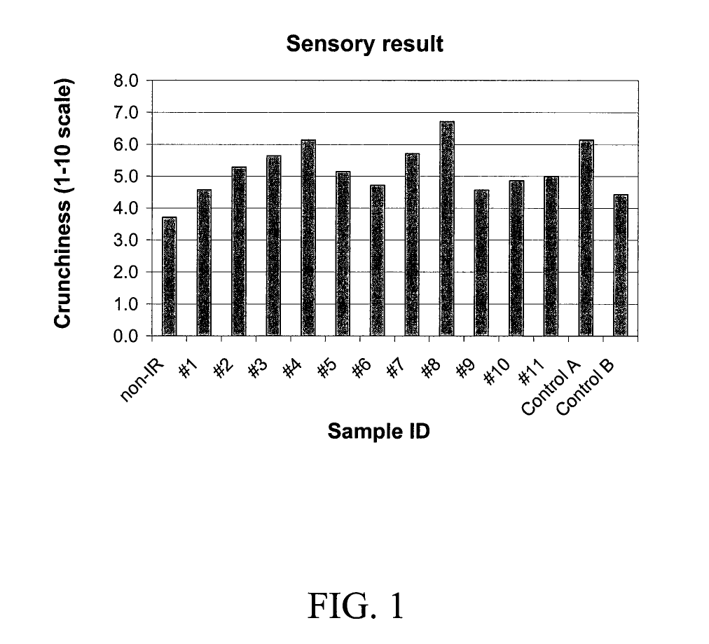

The crunchiness of the IR treated sorbitol coated pellets was evaluated by selected sensory panels and measured by a using a thermal mechanical analyzer (TMA) (PERKINELMER® DIAMOND® TMA). The pellet crunchiness was evaluated by 7 people using a 1-10 scale (1: softest, 10: crunchiest) to evaluate the crunchiness of each pellet coating. The average crunchiness was calculated and the graph is shown in FIG. 1.

Black current isomalt coated pellets were used for sorbitol coated pellet development comparison. For example, the crunchiness of sorbitol coated pellets should be comparable with commercial isomalt coated pellet crunchiness. Two isomalt samples (Control A and Control B) were used as a control sample (shown in FIG. 1). All pellets had same flavor of black current (cassis).

The control crunchiness of isomalt coated control A and control B pellets were 6.1 and 4.4, respectively. Most IR treated sorbitol coated pellets were within or over the range of 4.4 and 6.1. The sensory data showed one of the lowest scores with a non-IR treated sample.

The softening point of sorbitol coated pellets was measured by the TMA (e.g. to test the coating hardness). The sorbitol coating of the pellet was separated from the gum center and placed in the TMA. The softening point was measured by the onset temperature of probe position during a continuous increase in temperature. The probe maintains constant force during the measurement. The linear relationship between the pellet crunchiness and the softening point has been discovered by previous research. According to previous test data, a softening temperature around 90° C. provides sufficient crunchiness of the sorbitol coating on the pellet.

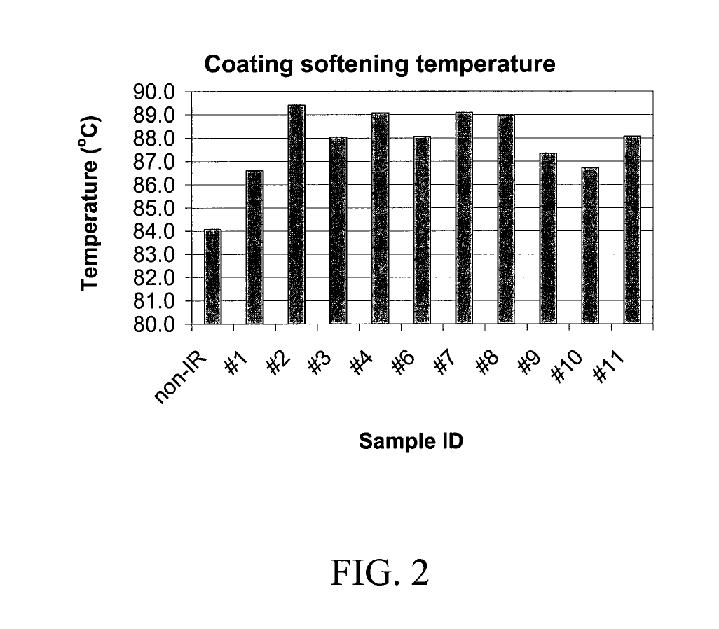

FIG. 2 shows the comparison of softening points of the IR treated sorbitol coated pellets. The TMA data shows the prominent low softening point of a non-IR treated sample, which also showed the lowest sensory evaluation point. It was not possible to compare the sorbitol and isomalt pellet crunchiness by TMA because there was no TMA data for the isomalt pellets.

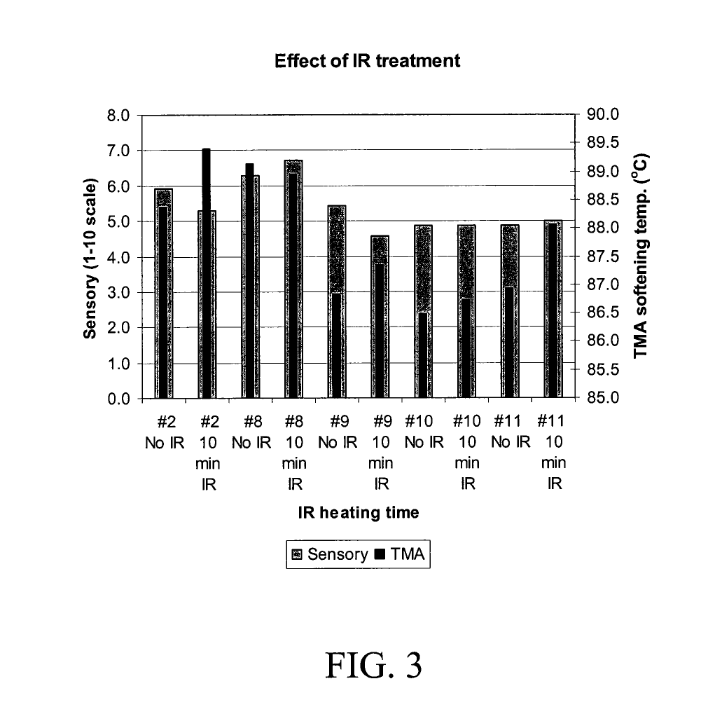

FIG. 3 shows the effect of IR treatment compared to non-IR treatment using various samples subject to different tempering conditions (e.g. air drying done after the final coating application and prior to the IR treatment). Each numbered pair corresponds to the same tempering conditions. Subsequently, one of the pair was exposed to IR treatment while the other was not. FIG. 3 shows the crunchiness difference of untreated and 10 min IR treated sorbitol coated pellets. All samples except for the 2^{nd} sample pair showed improved crunchiness with IR treatment with the TMA analysis. Because the sensory data was subjective as viewed by the consumer, the data is more variable.

The appearance of final IR treated sorbitol coated pellets showed comparable results with commercial pellets. Overall, improved crunchiness was achieved with short (10 min) IR treatment.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
providing a coated confectionery; and
applying infra-red radiant energy to the coated confectionery.

2. The method of claim 1, wherein the infra-red radiant energy is applied to the coated confectionery at an intensity ranging from about 50-400 W/min.

3. The method of claim 1, comprising rotating the coated confectionery while the infra-red radiant energy is applied.

4. The method of claim 3, wherein the coated confectionery is rotated at a speed ranging from about 5-50 rpms.

5. The method of claim 1, comprising supplying air flow to the coated confectionery while the infra-red radiant energy applied.

6. The method of claim 5, wherein the air flow is supplied at a rate ranging from about 0.125-2.5 m³/min/kg.

7. The method of claim 5, wherein the air flow has a temperature ranging from about 20-70° C.

8. The method of claim 1, wherein the infra-red radiant energy is applied to the coated confectionery from about 1-60 minutes.

9. The method of claim 1, wherein the confectionery is selected from the group consisting of hard candy, gummy candy, jelly candy, chewy candy, chewing gum, chocolate, fondants, nougats, compound candy, caramels, taffies, dragees, suspensions, lozenges, compressed tablets, capsules, nuts, snack foods and combinations thereof.

10. A method comprising:
providing a confectionery;
applying at least one coating to the confectionery to produce a coated confectionery; and
applying infra-red radiant energy to the coated confectionery.

11. The method of claim 10, wherein the coating comprises a syrup having an ingredient selected from the group consisting of sugar sweeteners, sugar-free sweeteners, polyols, flavors, colors and combinations thereof.

12. The method of claim 10, wherein the coating comprises a molten polyol selected from the group consisting of sorbitol, maltitol, xylitol, erythritol, mannitol, isomalt, lactitol and combinations thereof.

13. The method of claim 10, wherein the infra-red radiant energy is applied to the coated confectionery at an intensity ranging from about 50-400 W/min.

14. The method of claim 10, comprising rotating the coated confectionery at a speed ranging from about 5-50 rpms while the infra-red radiant energy is applied.

15. The method of claim 10, comprising supplying air flow to the coated confectionery at a rate ranging from about 0.125-2.5 m³/min/kg while the infra-red radiant energy applied.

16. The method of claim 15, wherein the air flow has a temperature ranging from about 20-70° C.

17. The method of claim 10, comprising supplying a drying air flow to the confectionery while the coating is applied.

18. The method of claim 10, comprising supplying a tempering air flow to the confectionery after the coating is applied and before the infra-red radiant energy is applied.

19. A method of manufacturing a coated confectionery, the method comprising:
providing a confectionery;
applying a plurality of coating layers to the confectionery to form a coated confectionery, the plurality of layers including at least one coating layer having a component selected from the group consisting of molten polyol, polyol syrup, sugar syrup and combinations thereof;
rotating the coated confectionery; and
applying infra-red radiant energy to the rotating coated confectionery.

20. The method of claim 19, wherein the step of applying the plurality of coating layers is chosen from the group consisting of spraying, panning and combinations thereof.

21. The method of claim 19, wherein the coating layer comprises an ingredient selected from the group consisting of sugar sweeteners, sugar-free sweeteners, polyols, flavors, colors and combinations thereof.

22. The method of claim 19, wherein the infra-red radiant energy is applied to the coated confectionery at an intensity ranging from about 50-400 W/min.

23. The method of claim 19, wherein the rotating is at a speed ranging from about 5-50 rpms.

24. The method of claim 19, comprising supplying air flow to the coated confectionery while the infra-red radiant energy is applied.

25. The method of claim 24, wherein the air flow has a temperature ranging from about 20-70° C.

26. The method of claim 19, comprising supplying a drying air flow to the confectionery while the coating layers are applied.

27. The method of claim 19, comprising supplying a tempering air flow to the confectionery after the coating layers are applied and before the infra-red radiant energy is applied.
